(19) United States
(12) Patent Application Publication
(10) Pub. No.: US 2012/0300080 A1
(43) Pub. Date: Nov. 29, 2012

(54) System and method of semi-autonomous multimedia presentation creation, recording, display, network streaming, website addition, and playback.

(75) Inventor: Steven George Batson, Orange City, FL (US)

(73) Assignee: Steven George Batson, Orange City, FL (US)

(21) Appl. No.: 13/474,904

(22) Filed: May 18, 2012

Related U.S. Application Data
(60) Provisional application No. 61/489,250, filed on May 24, 2011.

(51) Int. Cl. H04N 7/18

(52) U.S. Cl. 348/159; 348/E07.085

(57) ABSTRACT

The invention disclosed is a software and hardware system that allows complex multimedia presentations to be created, performed, recorded, streamed over a network, and automatically added to a website, without the need of human input other than that of the presenter. It is the first system to combine the following technologies into a single system of interdependent hardware and software: presentation creation software, network communication, media syncing, multiple remotely controlled motorized camera apparatuses, motion tracking, voice recognition, media projection software, recording and streaming of both live and recorded media, and automated website management.

### CROSS-REFERENCE TO RELATED APPLICATIONS

This nonprovisional utility patent application makes reference to the provisional utility patent application with application No. 61/489,250 filed on date May 24, 2011 (May 24, 2011).

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable

### FIELDS OF THE DISCLOSED TECHNOLOGY

The disclosed technology relates to methods of creating and displaying audio-visual content in multimedia presentations, recording and playing back multiple synced media sources, motion tracking, voice recognition, and automated website management.

### BACKGROUND OF THE INVENTION

A “multimedia presentation” is the transfer of information from one or more “presenters” to an audience of one or more people, where audio-visual elements are utilized. The most typical multimedia presentation is a single presenter delivering a speech to an audience of multiple people using images projected on a screen that illustrate various aspects of the speech. In this case, the presenter usually controls the display of the images using his/her laptop he/she has carried to the presentation environment. Many presentations integrate audio, video, and plain text as well. The growing popularity of web-based videos has given rise to the demand for software that allows for presentations to be “streamed” to a live audience over a computer network, usually the Internet. For multiple media elements to be delivered over the network, the video stream must not only include the video and audio of the presenter, but also a means of transmitting any additional media elements the presenter is displaying to the audience. Typically, the media elements are “mixed” into the video stream by another human using a mixer/switcher hardware device. The complexity of these tasks usually requires this human to also manage the streaming software, as well as select the media in another software interface to display to the audience at the correct moment during the presentation. Configuring the live stream requires knowledge of the network and ultimately the website where the stream will be viewed. In addition, multiple cameras are often desired to produce multiple angles that can be switched between as a “Director”, another human, sees fit. Each camera typically requires an additional human to move it in order to create the desired shot. The Director watches the display of each camera on individual monitors (a monitor for each camera), and chooses the shot to send in the live stream, also using a mixer/switcher. To display additional media, a computer display output can be connected to the mixer as well. Each camera, computer output, and video playback device (such as a DVD player) requires a monitor so the director can see which shot to choose. Lastly, if the video, audio, or media elements are to be stored on a server for viewers to watch later, a human must also move the media elements to the correct location on the server and create links so that viewers can access them. To attain this technical level of multimedia presentation, recording, and live or recorded playback, multiple people must be involved and numerous hardware (cameras, switcher, monitors, media playback devices) and software programs (video recorder, audio recorder, video converter, media display) must be used. The size and cost of such a system is high, and for these reasons are not typically used by the majority of presentations delivered around the world. The embodiments in this disclosed technology provides a solution to these problems.

### BRIEF SUMMARY OF THE INVENTION

The invention disclosed is a software and hardware system that allows complex multimedia presentations to be created, performed, recorded, streamed over a network, and automatically added to a website, without the need of additional human input other than that of the presenter. All technical website configurations necessary to enable the system to communicate with the server is performed autonomously by the system when a user downloads and installs the software on the Media Computer and Control Device. Once installed and setup, a single presenter (not requiring deep technical knowledge of such systems) uses a Control Device running the Control Device Software Application, to create the presentation by adding media elements such as videos, images, audio, text, web pages, and other software applications, to a scrollable list. When the presentation is performed, the presenter uses a computing device, preferably a light-weight wireless touchscreen tablet, to remotely control a 2nd computer referred to as the Media Computer. Messages are sent from the Control Device to the Media Computer to start and stop recording and/or streaming of live video. Once recording/streaming has started, the interface on the Control Device displays a list of media elements that the presenter selects at various moments throughout the presentation. When a media element is selected, the same media element is displayed by the Media Computer on display devices (such as a projector or HDTV, but not limited to these devices) to a local audience attending the presentation in person, and/or on a “Media Playback Software Application” to a remote audience viewing the presentation over a network. The timing of each media element usage is saved in a “Session Information File” and later used to display the same media elements at the same moments in the presentation when viewed on the Media Playback Software Application. The need of humans to operate multiple cameras is removed because each camera can be set to autonomously track the presenter using a small, battery powered infrared light the presenter wears. Each camera sits on top of a motorized tripod head that also contains an inexpensive infrared-only camera, which determines where the presenter is, and moves the camera into position accordingly. Different camera angles can either be selected by the presenter in the interface on the Control Device Software Application or can be set to switch to random or fixed shots at random or fixed times. A button in the Control Device Software Application interface can be used so that when pressed, voice recognition is activated on the media computer to display media that the presenter speaks into his/her microphone. For example, “Slide five”, when spoken by the presenter, tells the Media Computer Software Application to immediately display the media element entitled “Slide five” in the presentation. All media to be used in the presentation that the presenter desires to be seen by the remote audience can either be uploaded to a website prior to the presentation, or the Media Computer Software Application can be configured so that, when the presentation concludes and recording is stopped, all media elements that were used in the presentation are automatically uploaded to a server and all links automatically created. Using this system, a single presenter can deliver a highly complex multimedia presentation with multiple cameras to multiple audiences, both live and after the presentation, without being required to have the technical knowledge of any such systems.

### BRIEF DESCRIPTION OF THE SEVERAL VIEWS OF THE DRAWING

The drawings presented here are an example of one implementation of the invention and do not limit its usage in any way to other implementations.

FIG. 1 shows an example implementation environment of the system.

FIG. 2 shows an example camera mounted on top of a motorized camera platform with two motors capable of both pan (left-right) and tilt (up-down) movement and also the infrared-only detecting camera.

FIG. 3 shows an example human wearing an infrared light and holding a control device running the Control Device Software Application.

FIG. 4 shows a detailed example design of the motorized camera platform in both solid and wireframe views.

FIG. 5 shows a detailed example design of the battery-powered infrared light mounted on an assembly that clips to the presenter's clothing during the presentation and is detected by the infrared-only camera.

FIG. 6 shows an example Video Processing Unit.

FIG. 7 shows an example Audio Processing Unit.

FIG. 8 shows an example interface of the Control Device Software Application in Edit Mode.

FIG. 9 shows an example interface of the Control Device Software Application in Present Mode.

FIG. 10 shows an example interface of the Media Computer Software Application.

FIG. 11 shows an example interface of the Media Playback Software Application.

FIG. 12 shows an example Media Menu with links created by the Media Menu File.

### DETAILED DESCRIPTION OF THE INVENTION

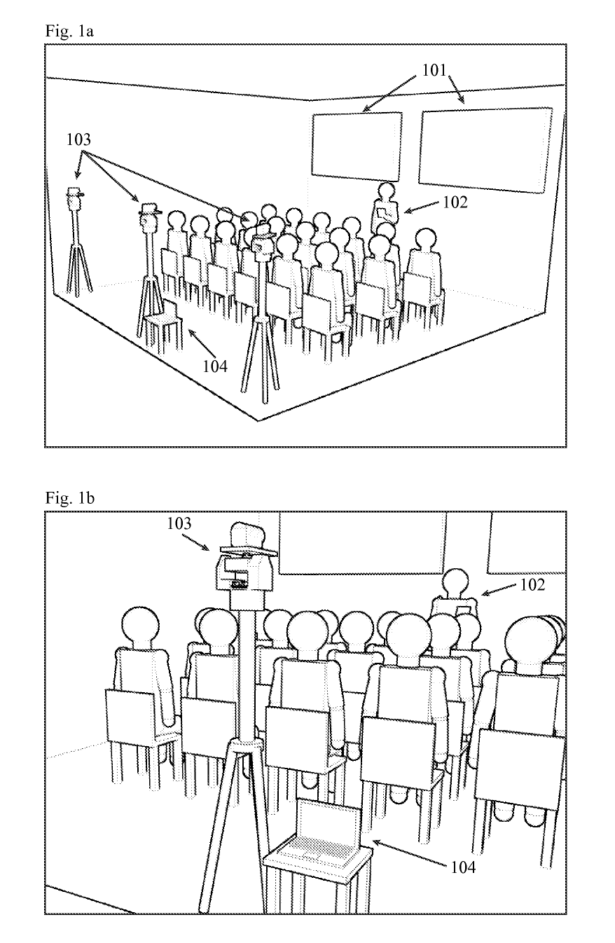

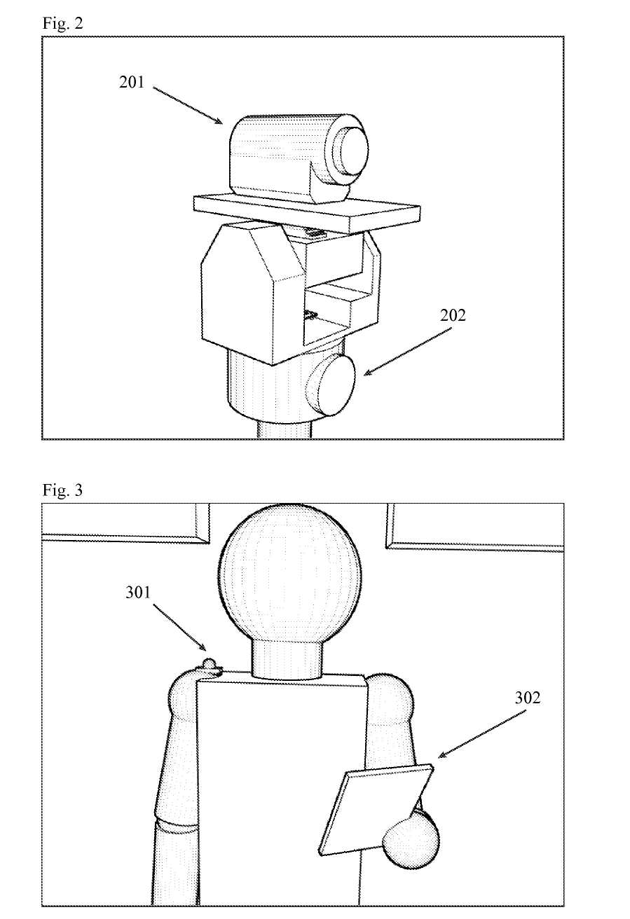

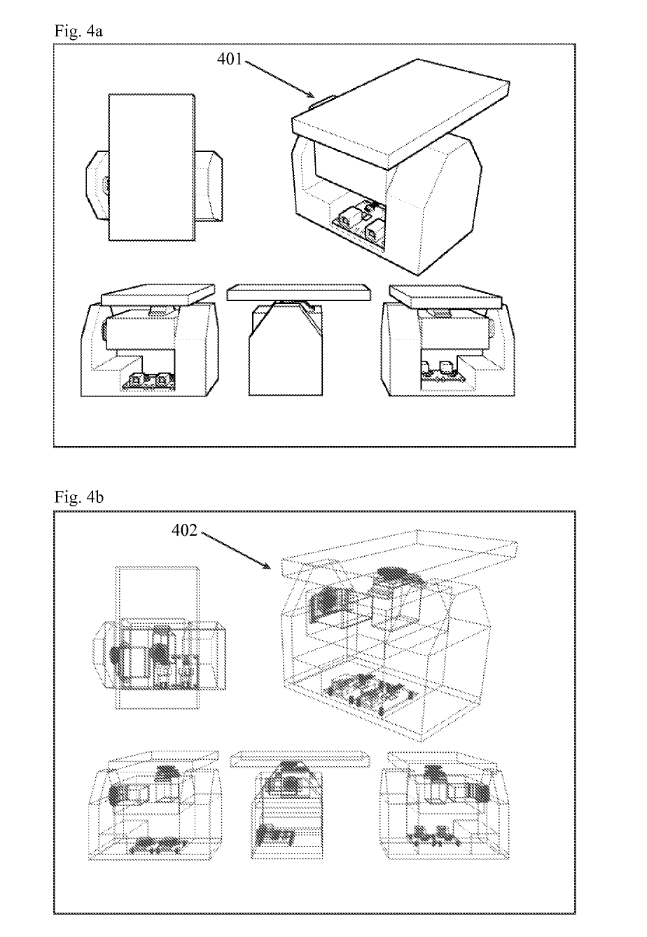

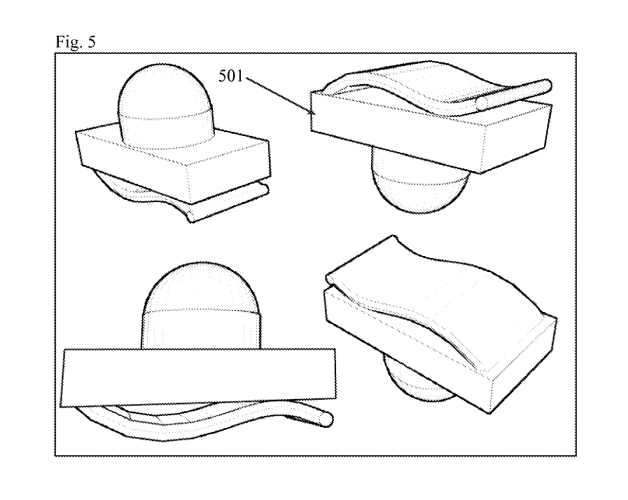

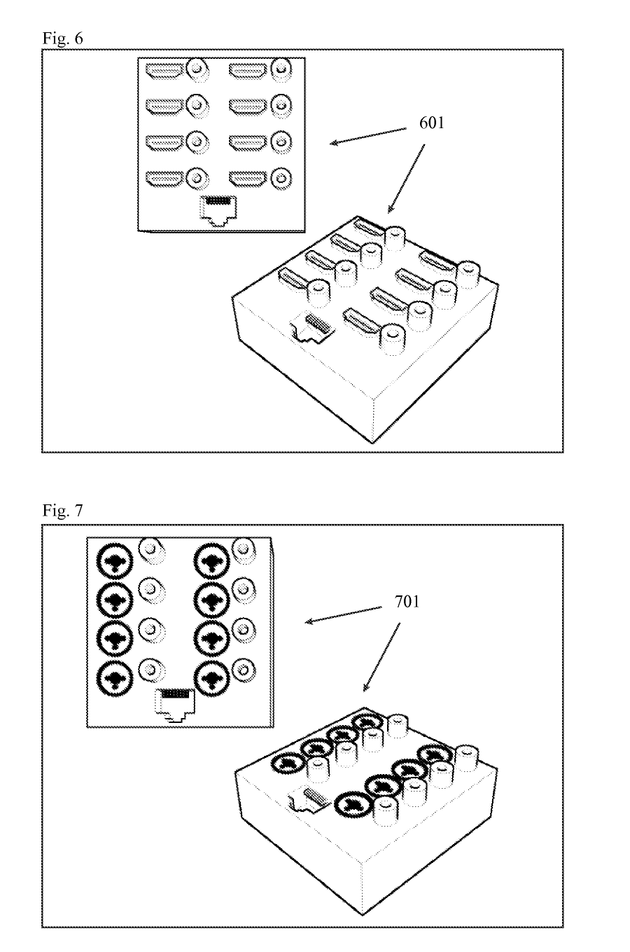

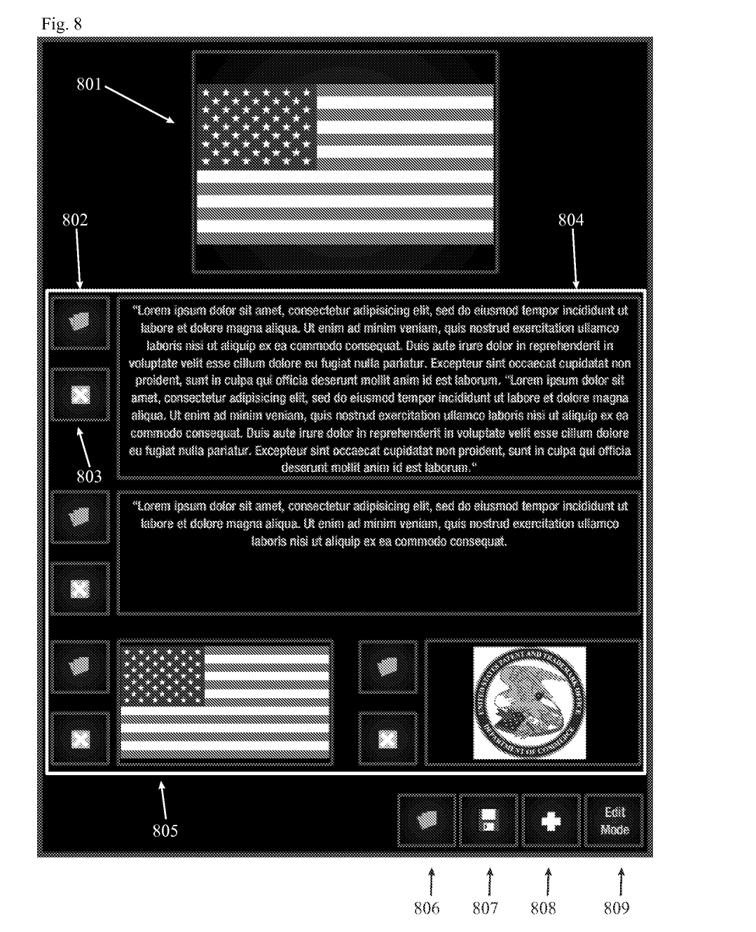

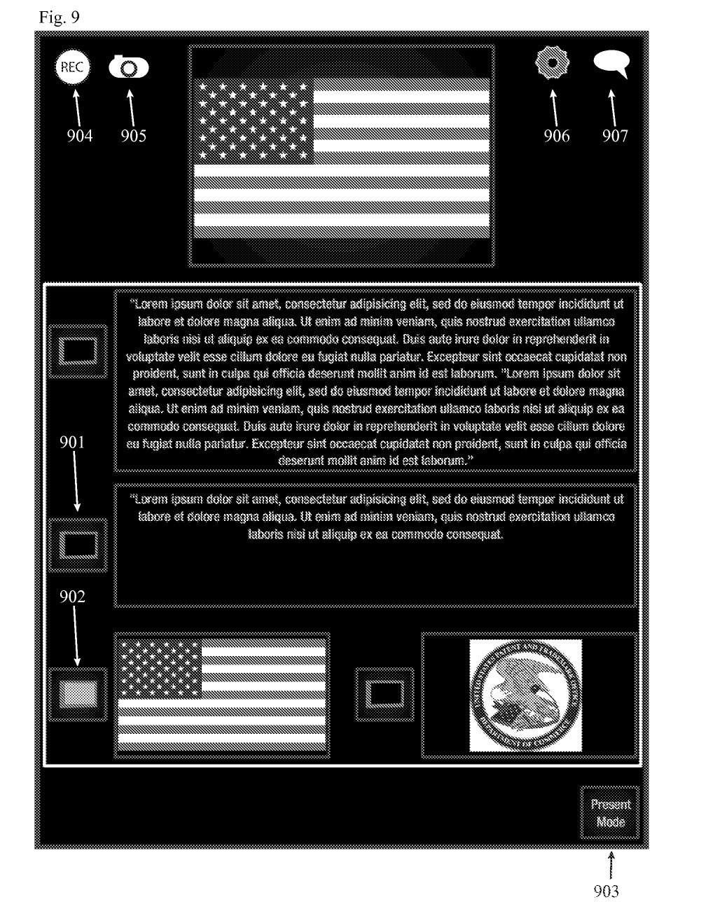

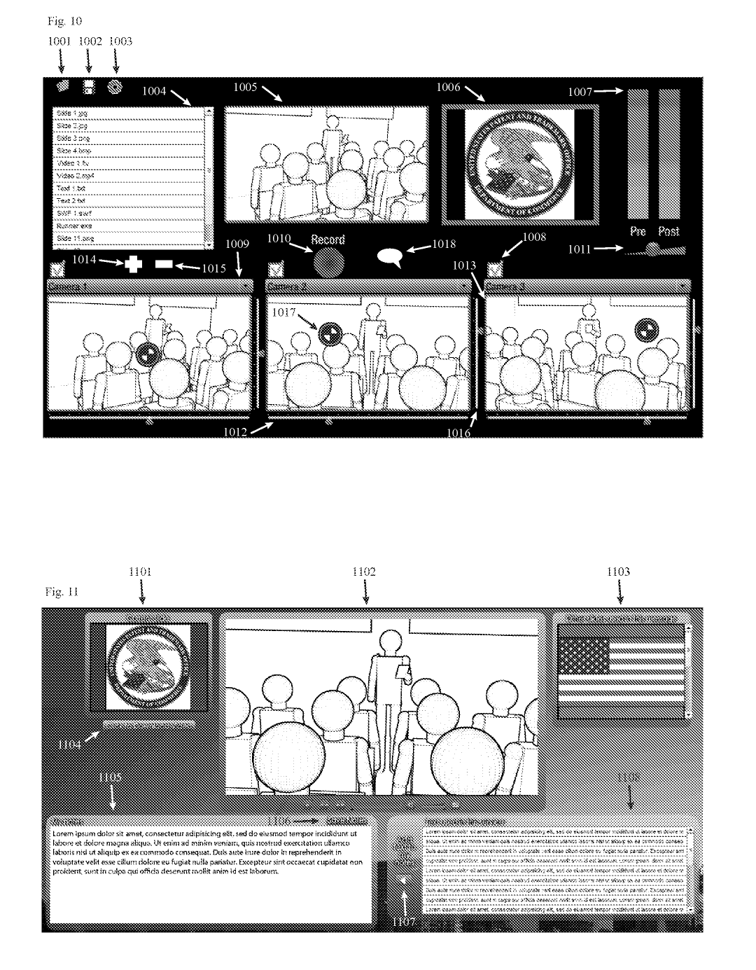

The invention disclosed is a software and hardware system that allows complex multimedia presentations to be created, performed, recorded, streamed over a network, and automatically added to a website, without the need of additional human input other than that of the presenter 102 by utilizing motion tracking and voice recognition. FIG. 1a and FIG. 1b show an example of how various elements of the system would be setup in a presentation environment. 101 are display devices, in this case HDTVs, mounted on a wall behind the presenter 102. The HDTVs are connected to the Media Computer 104 in the back of the room by cables that run through the wall, ceiling, or floor. These display devices display the media such as images, videos, websites, text, or other applications that are being sent from the Media Computer 104 running the Media Computer Software Application (FIG. 10). The presenter 102 stands in front of the audience holding the Control Device 302, which runs the Control Device Software Application (FIG. 8 and FIG. 9), which sends commands over a wireless network to the Media Computer Software Application (FIG. 10). Cameras 201 are mounted on top of motorized platforms (FIG. 4) which are mounted on top of tripods 103. There are two cameras on top of each tripod. Camera 201, which records and/or streams video to be viewed by an audience, and the other 202, which captures infrared light only and is used to track the infrared light 301 and 501 worn by the presenter 102. An optional component is the Video Processing Unit 601 that converts and/or compresses video signals from video sources and sends them to the Media Computer. Another optional component is the Audio Processing Unit 701 that converts and/or compresses audio signals from the audio sources and sends them to the Media Computer.

The Presentation Creation and Delivery Application.

1. Presentation Creation.

The presenter 102 first creates the presentation in the Control Device Software Application. During creation, the Control Device Software Application can run on the device he/she wishes to use as the Control Device 302, or on another computing device. The frame 801 shows the user the current media item being displayed to the local audience on the display devices 101 and to the remote audience in the Media Playback Software Application in window 1102. The interface can be toggled between “Present Mode” or “Edit Mode” by pressing the toggle button 809, which then becomes 903 in Present Mode. When button 903 is pressed, Present Mode returns to Edit Mode and the button once again becomes 809. Present Mode provides the user with the exact interface he/she will use when presenting. In Edit Mode, the presenter 102 adds empty “tiles” to a vertical, scrollable list 804 using the “Plus” button 808. A tile can be removed by clicking the “X” button 803 next to the tile. Each tile can have text typed into it, have a video, a still image, audio, text files, or applications added to it using the “Open” button 802 next to each tile. The Open button opens a list of files that is compiled from a “Media Folder” location that is chosen by the user. If the text box has a web page URL typed into it, the software automatically recognizes this and will connect to that website, displaying the web page in the tile. If an image or video is chosen after the “Open” button 802 is pressed, a still image of that media item is placed in the boxes 805 in the scrollable window 804. If an application is selected, the “Application” icon is placed in box 805 and the name of the application appears under it. If a text file is chosen after clicking the “Open” button 802, the text in the file is parsed and added to the empty text box in separated sections, each section clickable by the user. When a section of text is clicked by the user during the presentation, the text in that section only will appear on the display device(s). More on presentation delivery is explained in the “Presentation Delivery” section below. If the text file has never been divided into sections by the Control Device Software Application, all text will be added into the text box as one section. The user at any time can choose to customize the text sections by double-clicking the text box. An empty text box appears that allows the user to type in a character string that the imported text will be searched for to divide the text into sections. The text may also be manually divided at any point the presenter 102 chooses. The option of creating custom images is available that allows for drawing lines and shapes, coloring them, and typing text that overlays on top of the custom images. The custom image is added to the scrollable list 804 in a box 805, with controls 802 and 803.

2. Presentation Schedule File and Device Syncing.

When the presentation creation has been completed, the “Save” button 807 is pressed and text data and paths to media are saved in a file called the “Presentation Schedule File”, because it lists all media and text in the order (or schedule) the presenter 102 has created. When saving this file, the user is given the option of uploading any media added in the Presentation Schedule File to one or more websites where live viewers may watch during the presentation. More about this will be described below in the “Media Syncing” section. Before the presentation begins, the presenter 102 opens the schedule file by clicking the “Open” button 806 on the control device, which in turn sends a message to the media computer over the network telling it which Presentation Schedule File was opened. If the same Presentation Schedule File is not found on the Media Computer, a file with the same name is created, and all media elements are searched for in the Media Folder on the Media Computer. Any media elements not found are automatically transferred from the Control Device to the Media Computer into the proper location specified in the Presentation Schedule File. Because this media file transfer may take more than a few seconds (depending on the size of the media and network speed), it is best practice to make sure all media elements are present on the Media Computer some time before the presentation begins. This process of syncing media elements between the Control Device and Media Computer will be referred to as “Device Syncing”. Device syncing can also be applied the opposite direction, from the Media computer to the Control device, if the presentation was created on the Media Computer. If the presentation was created on a device other than the Control Device or Media Computer, the Presentation Schedule File and corresponding media must be transferred to either Control Device or Media Computer, then synced from one device to the other, or transferred to both devices. Once both devices contain all necessary files, the presenter 102 may begin delivering the presentation. The presenter 102 may begin presenting even if all media elements are not present on the Control Device or Media Computer, but those elements not present will not be shown during the presentation.

3. Presentation Delivery.

To deliver the presentation, the presenter 102 clicks the “Edit Mode” button 809 to switch to “Present Mode”, shown by the button 903. This removes the buttons that add and remove elements (802, 803, 806, 807, and 808) and replaces them with a single on/off toggle button 901 next to each element in the vertical list. A record icon 904 at the top of the screen allows the presenter 102 to start and stop recording and/or streaming video and/or audio on the Media Computer. Below this button is a window 801 that shows media that currently appears on the audience media display (projector, screen, remote web page, etc). Below this is the vertical, scrollable window 804 containing all media elements and text in the presentation. The presenter 102 can drag the vertical list up and down to scroll through the elements. When the presenter 102 wants to display an element in the list, he/she simply touches or clicks the on/off toggle button 901 next to that particular element. When that media element is displayed, the button 901 becomes button 902 next to the given element. This sends a message through the network connection to the Media Computer, telling it which item to display. If the Media Computer is connected to a display device, for example a HDTV as in 101, the Media Computer Software Application will display the element on the display device. If multiple displays are connected to the Media Computer, the message will contain which device(s) should display the media, or on none at all. The presenter 102 sets which display device each media element will be displayed on in a drop-down menu at any time before or during the presentation when in Edit mode by double-clicking on the media element in the scrollable list 804. At any time during a presentation the presenter 102 can switch to “Edit” mode using the “Present Mode/Edit Mode” toggle button (809, 903) and add elements to the presentation. Additionally, when each element toggle button is selected, the element name and the time it was clicked is added to a string variable in the Media Computer Software Application. At the end of the presentation, this text string is written to a Presentation Schedule File on the Media Computer, which will be used later during playback of the presentation on a web page. This process will be described in more detail in the “Post-presentation playback” section below. At any time the presenter 102 may click the “Cameras” button 905 to open a window that contains all available camera feeds connected to the media computer. The feed currently being sent to the remote audience is surrounded by a colored box. The presenter 102 then can press any of the camera feed displays, which sends a message to the media computer to send that selected feed to the remote audience. A “Speech” button 907 is present that when selected, sends a message to the media computer to begin analyzing the audio input for words of speech. When the button is un-selected, another message is sent telling the media computer to stop analyzing speech. This will be explained below in the “Speech Recognition” section.

The Media Computer Software Application

The Media Computer runs a single application that captures and records live video from one or more sources, captures and records live audio from one or more sources, performs motion tracking which controls motorized tripod heads that follow the presenter 102, speech recognition, sends a stream of video, audio, and text data to a web page, creates and modifies remote files on a server over a network, and receives messages from the control device communicating which function(s) to perform. The Media Computer Application can be controlled remotely by receiving messages over a network connection, or be operated by a user at the Media Computer. A Presentation Schedule File is opened by clicking button 1001, which then displays all media element titles in window 1004. Elements can be added to the schedule by the user clicking the plus button 1014, which opens a window that allows the user to select files to add. After a media element is selected in the list, clicking the minus button 1015 will remove the element from the list. After modifications are made to the schedule, the modified Presentation Schedule File may be saved using the save button 1002.

1. Video Capture.

When a camera device is connected to and recognized by the Operating System of the media computer, the Media Computer Application converts and compresses the video signal into a format that can be streamed over a network and played on a web page in the “Media Playback Application”. The presenter 102 can choose which format properties (size, bitrate, etc) he/she desires the software to convert each video feed to by selecting the “Formats” item in the “Settings” drop-down menu, which appears when the 1003 or 906 button is pressed. The application displays a video feed from each camera device connected in its own small window 1013. All video windows reside in a larger, scrollable and scalable window that allows the user to position each video at a customizable size and location. Above each window is a drop-down menu 1009 that contains a list of all connected cameras and allows any camera feed to be selected and displayed in any window. If the motorized platforms (FIG. 4) are not autonomously tracking the infrared light 301 and 501 worn by the presenter 102, each motorized platform (FIG. 4) can be controlled manually by clicking the check box 1008 above each video window. Once checked, the motorized platforms can be controlled by the horizontal sliders 1012 and vertical sliders 1016, the keyboard arrows (up, down, left, right), and various keys on the keyboard that control movement at various speeds. Spinning a mouse wheel controls platform vertical position and rotating the wheel left and right controls the horizontal position. Each video window contains a circle 1017 that the user can click and drag around the window to move the platform in all directions (up, down, left, right, diagonal, circular, etc). When moving the position circle 1017, the horizontal and vertical sliders follow the location of the circle. When all desired camera devices are connected to the media computer, the presenter 102 (if the Media Computer Software Application is being controlled remotely by the Control Device Software Application) or the user (if the Media Computer Software Application is being controlled by a human at the Media Computer) may click on the camera feed window of any of the connected camera devices to send that feed to the “main video display” window 1005 at the top of the Media Computer Application. When the chosen video feed is seen in the main video display window, the presenter 102 may click the “Record” button 1010, which displays a list of options to the presenter 102 to either stream the video to a remote server, stream the audio to a remote server, record the video to the local computer, record the audio to the local computer, or any combination of these four options. Audio capture is discussed in the below “Audio Capture” section. Once all options are selected, the presenter 102 clicks the “OK” button and the selected media begins streaming and/or recording to the chosen destination(s). Before remote streaming can be accomplished, the presenter 102 must input at least one remote destination URL in the “Streaming” item in the “Settings” drop down menu from button 1003 or 906. The Media Computer Application stores a list of all remote destination URLs, along with all user configuration settings. To select another destination or multiple remote destinations, the user chooses the destination(s) from the “Streaming” item in the “Settings” drop-down menu that appears when the button 1003 or 906 is pressed. A default URL is created and saved in the system by the vendor server when the software is first installed on the customer computer. It is this ability to automatically configure new customer URLs for live streaming and file storage that adds great value to this system, as it does not need to be performed by the user and the user does not require any knowledge of the server-side or networking components. During the streaming/recording process, any video feed window may be clicked on to send that video to the media output stream. If saved locally, the video is saved in the “Media/Recorded Videos” folder. During recording, the text above button 1010 changes from “Record” to “Stop”. When the presenter 102 clicks the “Stop” button when streaming/recording is finished, the presenter 102 is given the option of uploading any local video that was saved to a local storage device connected to the Media Computer. Optionally, the user may upload any video in the “Recorded Videos” folder by clicking the “Upload” item in the “Settings” drop-down menu that appears when the button 1003 or 906 is pressed. The presenter 102 may set the application to save the streaming video on the remote server as it streams. The scrollable window 1004 contains a list of all media that was added to the presentation using the Control Device Software Application. A human operating the Media Computer Application may click on any of these elements, and when clicked, that media element is played on the live audience on a display device, as in 101. The window 1006 displays the media element currently being played to the live audience.

2. Video Signal Processing Units.

Many modern cameras output a video signal that, when connected to a Media Computer, is very processor intensive to capture, save to a local disk, and/or stream over a network. To offload this processing responsibility from the Media Computer, one or more cameras can be connected to a Video Signal Processing Unit 601. The Video Signal Processing Unit is connected to the Media Computer and receives control settings from the Media Computer Software Application communicating which video settings, such as size, bitrate, smoothing, and many other such settings, should be used for each video signal. This allows for video output from the cameras to be compressed and down-converted to settings chosen by the user in the “Video Converter Box Settings” item in the “Settings” drop-down that appears when the button 1003 or 906 is clicked. After being processed by the Video Signal Processing Unit, the video signals are sent to the Media Computer so that they are recognized by the Media Computer Operating System as cameras and can be captured using the procedure in the previous section (Video Capture). The settings for each camera can be adjusted independently so that the overall processing load on the Media Computer is sufficient for the capture and conversion of multiple cameras. Other cameras may still be connected directly to the Media Computer and captured as video inputs. Any combination of camera inputs may be used—multiple cameras connected directly to the Media Computer and no Video Signal Processing Unit connected to the Media Computer, multiple cameras connected directly to the Media Computer and also one or more Video Signal Processing Units connected to the Media Computer, or no cameras connected directly to the Media Computer and one or more Video Signal Processing Units connected to the Media Computer.

3. Audio Capture.

All audio input devices recognized by the media computer are listed in a window that appears when the user clicks the “Audio” item in the “Settings” drop-down that appears when the button 1003 or 906 is clicked. The user can choose one or more audio input devices that the Media Computer Software Application will capture audio from. All audio input devices not selected will not be captured. Each audio input has a volume level indicator 1007 that shows current signal amplitude. Each device also has a volume slider 1011 that can increase or decrease the input signal level. If the user chooses to record audio, the Media Computer Application saves all audio into the “Media/Recorded Audio” folder. The format and properties of each audio input signal can also be configured in the “Audio” item in the “Settings” drop-down that appears when the button 1003 or 906 is clicked. To begin audio streaming over the network or record to the local media computer, the user presses the “Record” button, which causes the check boxes labeled “stream the audio to a remote server” and “record audio to the local computer” to appear. Either or both may be selected. When the “OK” button is clicked, audio begins streaming to the destination(s) specified in the “Streaming” item in the “Settings” drop-down when the button 1003 or 906 is pressed and/or recording to the “Media/Recorded Audio” folder.

4. Audio Signal Processing Units.

Audio output devices may be connected to one or more Audio Signal Processing Units 701. These units contains hardware that samples and processes the audio signals connected, sums the signals, then sends the resulting summed signal to the Media Computer. The processes performed on each signal are determined by control signals sent to it from the Media Computer Software Application and saved in memory in the Audio Signal Processing Unit. Therefore, the Media Computer Software Application must only communicate with the Audio Signal Processing Unit when changing audio processing effect values. The user clicks the “Audio Processing Units” item in the “Settings” drop-down that appears when the button 1003 or 906 is clicked, which opens a window showing the amplitude of all audio signals currently being processed by the Audio Signal Processing Unit(s) and the audio processing effects that the Audio Signal Processing Unit can perform on each signal. The user may adjust the values of any of these effects in this window. When the values of the effects (such as volume gain or compression, but not limited to these effects) are changed in the Media Computer Software Application, the Media Computer Software Application sends the new values to the Audio Signal Processing Unit. This allows for complex computations to be performed on multiple audio signals that may not be possible on the Media Computer due to hardware processing speed or number of input limitations. It also removes the need for the presentation system to include a separate audio mixer to process multiple audio signals from multiple sources.

5. Media Syncing

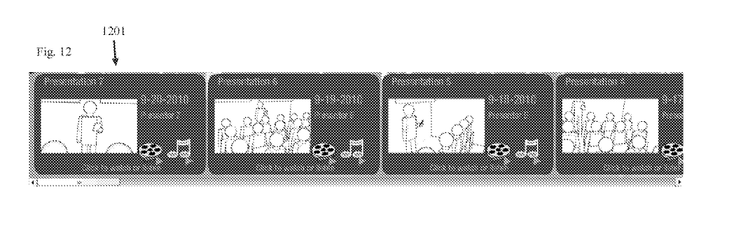

After the desired media to be used in the presentation (videos, audio, images, web pages, text, applications) are added to the Media Computer (either by manual addition or opening a Presentation Schedule File) and recording/streaming begins, the current date and time is captured and saved as the first element in an array variable in the Media Computer Software Application memory. Each time a media element is selected to be displayed to the live audience, a unique element identifier, date, and time the media element was selected is saved in the array in the Media Computer Software Application. At the conclusion of the presentation, this array is written to an external “Session Information File” and saved in the “Media/Session Information” folder on the Media Computer and the user is given the option to upload this file to one or more website servers, along with any recorded video or audio and media elements not already on the servers. When the video and/or audio of the presentation is played on a web page in the Media Playback Software Application, the Media Playback Software Application also reads the Session Information File and displays the additional media elements in the “Media” window 1103 on the web page at the same timing from the beginning of the presentation as it was originally displayed during the live presentation. In addition to the timing record of each media element, the file also contains additional information, for example, the name of the presentation, speaker, date, time, and location of the presentation, but not limited to only these values. The presenter 102 inputs these values before, during, or after the presentation using the “Presentation Details” item in the “Settings” drop-down that appears when the button 1003 or 906 is clicked. All input information, media element names, and timing appears in a window that can be edited by the user. When the recorded presentation is viewed by the online audience, this information about the presentation is displayed in the Media Playback Software Application in FIG. 11.

6. Remote Media Display.

If the presenter 102 intends to stream the camera and/or audio device input to a live remote audience over a network, all media elements to be used in the presentation can be uploaded to the remote website before the presentation using the “Add Media To Website” item in the “Settings” drop-down that appears when the button 1003 or 906 is clicked. During the presentation, when a media element is selected by the presenter 102 to be displayed to the live audience, a message is sent from the Media Computer Software Application to the Media Playback Software Application on the web page receiving the stream, telling it to display the same media element in window 1101. In this way, a remote audience can view the same media elements being used by the presenter 102 in the live environment at the same time the presenter 102 is displaying them to the live audience.

7. Website Upload Methods

The video and audio captured from camera and audio device inputs can be recorded to a local storage device connected to the Media Computer, streamed live over a network to a server that can in turn serve the media to a web page running a Media Playback Software Application, or both simultaneously. If streaming live, the video and audio files may be configured to be saved on the server during the stream for later viewing, eliminating the need for upload of recorded media stored locally after the presentation. This is accomplished by the presenter 102 checking the check box labeled “Save to Server” next to each website URL in the “Streaming” item in the “Settings” drop-down that appears when button 1003 or 906 is pressed. All credentials needed to upload, download, or otherwise modify files on the web servers are setup automatically and saved in the Media Computer Software Application when initially installed on the Media Computer in order to simplify and streamline the upload process for both technical and non-technical users of the system. If the presenter 102 is not saving the live stream on one or more servers and chooses not to upload the presentation video, audio and/or media elements at the conclusion of the presentation, the presenter 102 may upload the media at any time by selecting the “Add to Website” item in the “Settings” drop-down that appears when the button 1003 or 906 is clicked. The user is given a choice of all files and folders in the “Media” folder. When all desired files have been selected, the “Upload” button can be pressed, which begins uploading the chosen files. These media elements are uploaded to the remote URL(s) chosen in the “Streaming” item in the “Settings” drop-down that appears when the button 1003 or 906 is clicked. The media elements are uploaded into a new folder unique to each presentation. A progress bar is shown during upload of each item. At the conclusion of the upload of all items, the Media Computer Software Application automatically downloads a Media Menu File from each website that was uploaded to. Each Media Menu File consists of multiple elements of textual data, each element consisting of information about a unique presentation, for example and not limited to title, the date it was presented, name of presenter, and a URL on the server of the folder that contains the media files used in the presentation. The Media Computer Software Application adds new elements of textual data to the Media Menu File—one element for each presentation recorded that is to be added to the Media Menu 1201. After adding these new textual elements and saving the modified file locally, the Media Menu Files are uploaded back to the website each was downloaded from. When the Media Menu 1201 is run on a web page, it loads and parses the Media Menu File and dynamically creates links and displays, for example but not limited to, the title, date, and name of presenter, for each textual element in the Media Menu File. When a link is clicked on by a user, the Media Playback Software Application launches and begins playback of the selected presentation media. If the presenter 102 streams the presentation live and sets the Media Computer Software Application to save the captured video and audio on the server during the stream, these media elements have no need to be uploaded to the server, because they already reside there. Therefore, in this case, when the “Stop” button is clicked at the conclusion of the presentation, the user is asked which web pages on which websites, if any, should have links added to the Media Menu Files. After the user selects the desired web pages, the Media Menu Files are downloaded, the new textual elements added, the new files are saved, and then uploaded back to the websites each came from.

8. Motorized Tripod Platform

On top of each camera tripod a motorized platform 103, 401, and 402 can be attached. On top of the motorized platform a camera 201 can be attached. The platform contains two servo motors—one that pans and the other that tilts the camera. The Media Computer Software Application can also control zoom on cameras that support this function. The motors are controlled by signals sent from the Media Computer Software Application. The presenter controls the motors in the interface of either the Media Computer Application or the Control Device. On the side of each video feed window 1013 is a vertical slider 1016 that controls tilt and on the bottom of each video feed window is a horizontal slider 1012 that controls pan. In addition, a check box 1008 is placed above each video feed window that when checked, a circle 1017 appears overlaid on the video feed that can be clicked and drug around the video feed window, which sends control signals to the motorized platform 103, 401, and 402 that move the camera in any direction the circle moves (up, down, left, right, diagonally, circularly, etc). Because clicking on a video feed window also sends that selected video feed to the stream, if the check box 1008 is checked with the intent of using the circle overlaid on the video, the video will not be sent to the stream if clicked on. The check box 1008 must be un-checked before a click on a video feed window will be sent to the stream. Checking the check box also enables various other methods of control—pressing the arrow keys for left, right, up, or down movement, a mouse wheel that can be spun for tilt and shifted left and right for panning, or keys on the keyboard with varying speeds of movement in all directions.

9. Motion Tracking

If the presenter 102 enables motion tracking in the “Motion Tracking” item in the “Settings” drop-down menu that appears when the button 1003 or 906 is clicked, on each tripod a second, stationary camera 202 may be mounted that detects only infrared light. The presenter 102 wears a small, battery powered infrared light 301 and 501, which the infrared camera 202 detects and transmits in a video to the Media Computer Software Application. Each frame of this video is analyzed to find the pixel x and y coordinates of the infrared light, which through image processing algorithms, appears as a white circle on a black background. For each infrared camera, the user chooses a “home” position that the infrared light (the white circle) should occupy. The x and y coordinates of the light are compared to the x and y coordinates of the user-defined home position and the differences are used to send control signals to the motors to move the camera so that the light is moved to the home position. This application allows the presenter 102 to utilize multiple cameras to record presentation delivery without the need of humans to control the cameras. If more than one presenter 102 is involved in the presentation, each presenter may wear an infrared light of a different wavelength, therefore producing a different color in the capture infrared-only video. Each camera can then be set to track only a specific infrared color, or set to track multiple lights simultaneously by finding the midpoint between the lights and using that point to move the camera to the home position. This allows designated cameras to be assigned to tracking individual presenter movement, or a wider shot that will include multiple presenter lights designated by the presenter 102.

10. Speech Recognition

If the presenter 102 enables speech recognition in the “Speech Recognition” item in the “Settings” drop-down menu that appears when the button 1003 or 906 is clicked, a “Speech Recognition” button 907 and 1018 appears in the Control Device and Media Computer Application. When the button is pressed and held down, the Media Computer Application records the audio into a variable in memory until the button is released. When released, the recorded audio in the variable is analyzed to find the closest match to either a command function name or to a name of a media element in the list 1004 and 804. If the closest match is a command function, that command function is executed, for example but not limited to, “Start Recording” or “Stop Recording”. If the closest match is the name of a media element in the list 1004 or 804, that media element is immediately displayed on the display screen(s) 101, and if streaming live to a website, a message is sent over the network to the Media Playback Software Application to display the same media element in window 1101. If a media element has the same name as a command function, when that element is added to the list 1004 or 804, the presenter 102 is prompted to change its name.

11. Stand-Alone Mode.

The Media Computer Application can also run stand-alone, without the need of a presentation application giving it external commands. In this case, another human would sit at the media computer and control the Media Computer Application as the presenter 102 delivers the presentation, or the presenter 102 may choose to deliver the presentation using the Media Computer Software Application.

Playback

After the presentation, the presenter 102 may desire the presentation to be viewed at later times by an online audience on a web page (FIG. 11). In this disclosed technology, three items are required to accomplish this:

1. Presentation video and/or audio recorded files and media used by the presenter 102 during the presentation must be on a server in a folder unique for each presentation.

2. A web page must contain a dynamically created presentation Media Menu 1201 that contains information about and links to the presentations. These links are created at runtime when the Media Menu on the web page loads and parses a “Media Menu File” consisting of information about all available presentations, for example but not limited to, the presentation names, dates, titles, presenter(s), locations, etc. It also consists of the URL of the unique folder on the server that consists of the presentation video and/or audio recordings, any media elements used, and the Session Information file that contains the timing of each media element to display. The URL of each link contains the location of the Media Playback Software Application. Each URL also contains query strings of information about the presentation to be played back, including the location of the unique folder containing the specific presentation clicked on. For example, a link in the menu may be:

http://www.plus.com/Playback.html?media=2011.04.12.11.34.875.77&type=video
In this example, the name of the folder that contains the Session Information File that, when parsed by the playback application, will contain the name(s) of the media to play is “2011.04.12.11.34.875.77”.

3. A media playback application as in FIG. 11 on a web page that can parse its own URL to gather query strings containing data about the media it is to play. One query string is the location of the folder that the application should open, which contains the Session Information File. This file is loaded and parsed by the media playback application and then loads and plays the recorded video or audio file indicated by the media URL in the Session Information File. The recorded presentation is played back in a window 1102 on the web page. The window 1101 displays the media element used in the presentation, at the timing it was displayed in the original presentation, as indicated by the Session Information File. Scrollable window 1103 is a list of all the media used in the presentation, allowing the online audience to browse any media element at any time in the presentation. Button 1104 allows for the user to download the recorded presentation media as well as additional media used in the presentation. Window 1105 allows the user to take notes during the presentation and button 1106 allows the notes to be saved to the user's computer. The scrollable, selectable list 1108 holds all text that was used in the presentation and button 1107 allows the selected text in the list 1108 to be added to the notes window 1105, which can be saved with the user's notes by button 1106.

Live Presentation Viewing.

In addition to loading and playing recorded media files, the Media Playback Software Application is also capable of receiving and playing live streams. The name of the live stream file is contained in a query string in the URL that the Media Playback Software Application loads and parses. The name of the query string indicates the stream is live and not a recorded file. Below is an example of a URL that the media playback application will use to play a live stream:

“http://www.plus.com/Playback.html?liveVid=2011.04.12.11.34.875.77&type=video”
Notice the name of the query string is “liveVid”. This tells the player to connect to the file name “2011.04.12.11.34.875.77” and begin to play it from the live stream location of the website.

This disclosure of embodiments of the inventions set forth herein are but one detailed application of such technology that combines the above elements into a single system of applications working together to achieve the common goal of presentation creation, delivery, and playback. Therefore, it is to be understood that the inventions are not to be limited to the specific examples of the embodiments disclosed and that modifications and other embodiments are intended to be included within the scope of this application. Any specific terms used in this disclosure are indeed general and do not limit the scope of this technology to only those used in this disclosure.

1. A system for creating and delivering live and recorded multimedia presentations to multiple live and remote audiences, the system comprising:
a “media computer” software application that receives video and audio data from video and audio capturing devices that are connected either directly to the “media computer” or through external video and/or audio signal processing units, records video and audio data to local storage, streams video, audio, and presentation media data to single or multiple remote computers over a network, sends control commands to one or more external video signal processing units, sends control commands to one or more external audio signal processing units, executes motion tracking computer program algorithms to control the position and zoom of connected “motorized camera apparatuses”, performs voice recognition for control commands, displays presentation media on connected display devices, records time of use of such media for later playback, receives and displays on display devices live or recorded video and audio streams, uploads media to one or more remote computers, automatically or manually configures one or more websites to display the uploaded media for later playback, and allows the presenter during the presentation to either (1) switch between multiple video and audio inputs those which should be recorded and streamed or (2) set the “media computer” to autonomously change video and audio inputs based on desired criteria;
single or multiple “motorized camera apparatuses” that are connected to the “media computer”, send video and/or audio data to the “media computer” over said connection, and whose pan, tilt, and zoom functionality are controlled by either remote human control or autonomous computer program algorithms that reside either on the “motorized camera apparatuses” memory or are sent to the “motorized camera apparatuses” memory from a remote source;
a “control device” software application that serves as the presentation authoring application used to add media and text to the presentation prior to presentation performance, serves as the presentation delivery application that is used by the presenter at the time of the presentation to display previously added media to the presenter in a format that allows for quick media selection so that, when a media element is selected by the presenter, a control signal is sent to the “media computer” as to which media element has been selected by the presenter, which is in turn displayed on display devices connected to the “media computer” for the local audience to view and is also sent to any remote computers over a network so a remote viewing audience can see and/or hear the same media, allows the presenter to choose which video or audio input should be sent from the “media computer” to the display devices, and performs voice recognition for control commands;
a “media playback” software application that receives and plays live or recorded video and audio streams while simultaneously playing presentation media where, if live, plays the presentation media synchronously with the presenter and if recorded, uses a recorded timing reference to display presentation media at the same moments in the playback of the presentation that the presenter initially displayed said media;
a “network computer” software application that receives, records, stores, and transmits live or recorded video, audio, images, web pages, and other presentation media.

2. The system of claim 1, wherein the video output of the “motorized camera apparatuses” may be first connected to external video signal processing units that can receive single or multiple video inputs and perform signal processing algorithms based on control commands received from the “media computer” software application or the “control device” software application, and upon conclusion of said signal processing, the output of the external video signal processing unit is transferred to the media computer for recording and/or streaming to remote computers, thus off-loading complex video signal processing tasks from the media computer.

3. The system of claim 1, wherein single or multiple “motorized camera apparatus” may be connected either directly to the “media computer” or through an external video processing unit, and a video from each “motorized camera apparatus” is displayed in the “media computer” software application interface and in the “control device” software application interface, allowing the presenter with the “control device” or a user positioned at the “media computer” to select which “motorized camera apparatus” video should be recorded or streamed to the live or remote audience, thus eliminating the need for an external video switcher.

4. The system of claim 1, wherein single or multiple audio sources may be connected either directly to the “media computer” or through an external audio processing unit, and each audio input is displayed graphically in the “media computer” software application interface, allowing the user to apply independent signal processing to each audio input (the signal processing being performed by the “media computer” if an audio signal is connected directly to the “media computer”, and/or the signal processing being performed by the external audio processing unit if an audio device is first connected to the external audio processing unit and then output to the “media computer”) as well as to select which audio inputs should be used in the recording or stream, thus eliminating the need for an external audio mixer.

5. The system of claim 1, wherein voice recognition is the processing of human voice audio data by a software application running on one of the computers connected to the system of claim 1, to produce a command to be performed by any element in the system of claim 1.

6. The system of claim 1, wherein computer program algorithms may be used to control the pan (horizontal movement), tilt (vertical movement), and zoom of each “motorized camera apparatus” to follow a moving presenter or perform any other camera movements.

7. The system of claim 1, wherein the “media playback” software application contains a list of live and/or recorded presentations that is autonomously or manually modified by either the “media computer” software application or “control device” software application that allows a remote user to select which presentation to view over a network.
